(19) United States
(12) Patent Application Publication
(10) Pub. No.: US 2003/0112130 A1
(43) Pub. Date: Jun. 19, 2003

(54) Vehicle electronic check-off

(76) Inventors: Donald R. Templeman, Nacogdoches, TX (US); Jerry T. Sain, McKinleyville, CA (US)

Correspondence Address: Michael Jolly, 4th Floor, 1018 Preston, Houston, TX, 77002, US

(21) Appl. No.: 10/023,103

(22) Filed: Dec. 13, 2001

(51) Int. Cl. B60Q 1/00

(52) U.S. Cl. 340/425.5; 340/945; 340/635; 340/691.6

(57) ABSTRACT

An electronic check list for systematically checking and reminding a driver of a recreation vehicle the number of steps required before leaving a camp site or storage area to assure that all lines, blocks, jacks, antennas, hoses, etc are properly disconnected and stored before moving the vehicle. The vehicle electronic check-off helps prevent damage to the recreation vehicle and associated equipment as well as preventing damage to campground facilities such as water connections, power boxes, sewer connections, cable television and phone lines. The device is hand held and contains a number of momentary switches and associated red warning indicators each labeled for a particular check-off item, after all items are checked off a master green indicator is illuminated indicating to the operator that all is clear for moving the vehicle.

### TECHNICAL FIELD

The present invention relates to recreational vehicles and more particularly to a hand held electronic check-off device and method to remind the operator of a recreational vehicle to disconnect and or store numerous items to assure safe operation of the vehicle without damaging equipment or connections.

### BACKGROUND ART

Full enjoyment of recreational vehicles require the deployment of numerous items upon parking, including; jacks, wheel covers, canopies, antennas, chairs, tables, and connections such as electrical, sewer, cable, and telephone. When it comes time to move the recreational vehicle these numerous items must be properly disconnected and stowed prior to operating the vehicle. Often an item may be forgotten and left in a deployed arrangement thereby leading to the damage or loss of the item or connection. A reminder system or device which prompts the operator to check specific items before operating the vehicle would help reduce the risk of damaging or losing items. The present invention address these problems by providing an electronic hand held check-off list, which includes numerous momentary switches with associated red warning indicators each associated with a particular item of the recreation vehicle which should be checked before departure along with a green “go” indicator. The electronic check off device provides a means for easily assuring that each item deployed or connected is properly disconnected and stowed before operating the recreational vehicle.

### GENERAL SUMMARY DISCUSSION OF INVENTION

It is thus an object of the invention to provide an electronic check list which is hand held and approximately three inches wide and ten inches long by one inch thick and contains a number of momentary switches and associated red warning indicators, each associated with a particular “item position” plus a green “go” indicator. The name of each item associated with each red indicator and momentary switch can be changed to meet the individual demands of the user of the device. For example, one user might identify a particular item position as “water hose” while another user might identify the same item position as “power cord”. There may be any number of such item positions on a particular model of the invention. It is anticipated that ten or twelve such item positions would be on a unit. There would also be a master green indicator to show the recreational vehicle driver that all items have been checked and it is clear to move the vehicle. A series of enable/disable switches are also provided to allow the user to disable any item position he/she doe not desire to use. An audible alarm is also provided in the hand-held unit to warm the operator when no items have been checked. For easy access and usability, the device should be connected in the cab of the motor home or in the cab of a pull vehicle for towed recreational vehicles. Power for the device will come via a cord from the unit to a power outlet in the motor home or towed vehicle's dash or from hard wiring beneath the vehicle's dash. Twelve volt DC power that is turned on with the vehicle's ignition switch is required.

Accordingly, it is an object of the invention to provide a method and apparatus to reminding an operator of a recreational vehicle, in a systematic and self activating method, that there are a number of steps to be taken before leaving a camp site or storage area to assure that all lines, blocks, jacks, antennas, hoses, etc are properly disconnected and stored.

It is a further object of the invention to provide methods and apparatus to prevent damage to recreational vehicles and their equipment by promoting the proper disconnecting and storage of deployed associated equipment.

It is a further object of the invention to provide methods and apparatus to prevent damage to campground facilities such as water connections, power boxes, sewer connections, and cable TV lines by promoting the proper and complete disconnecting of these connections before moving the vehicle.

### DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 is a front view of a vehicle electronic check-off device illustrating the numerous associated items with check-off push button switches and red indicator “no go” indicators and a master green “go” indicator.

FIG. 2 is an electrical schematic of the electrical circuitry for controlling the check-off push button switches, red indicator “no go” indicators, master green “go” indicator, and timing circuit.

FIG. 3 is a recreational vehicle rear panel check-off format.

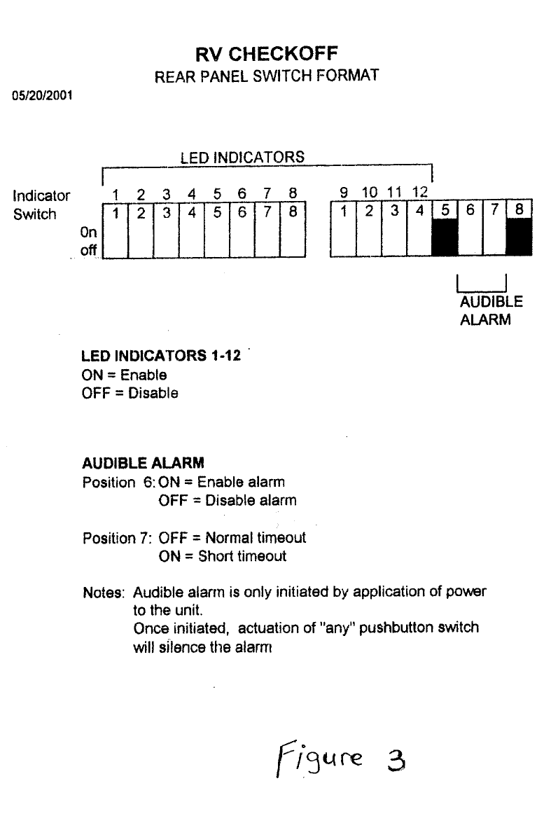

### EXEMPLARY MODE FOR CARRYING OUT THE INVENTION

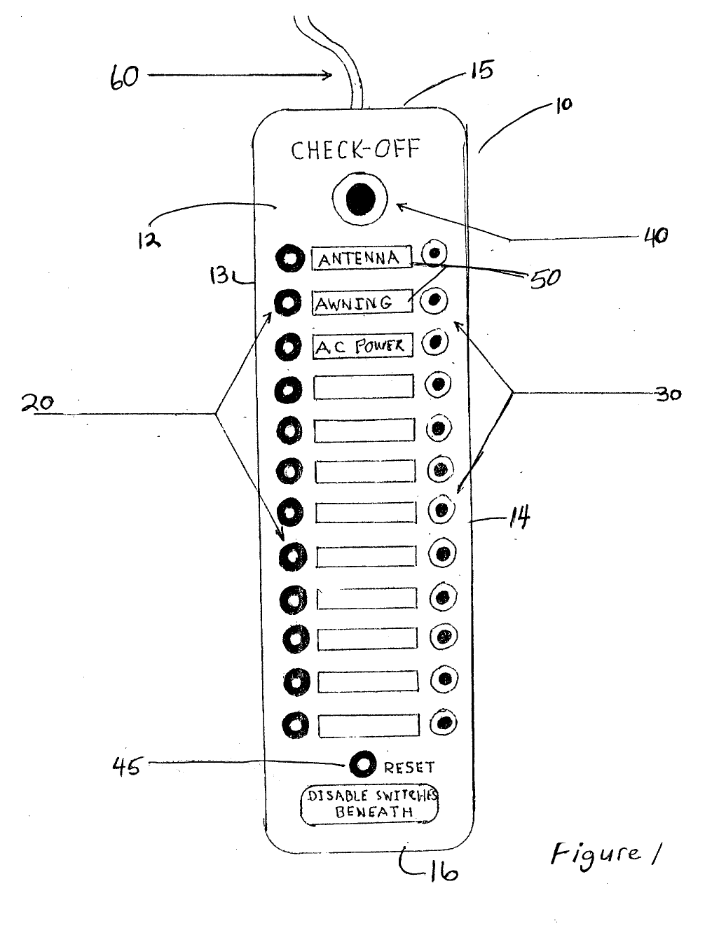

The vehicle electronic check-off 10 has an exterior case 11 which is dimensioned and designed for hand held use, and as illustrated in FIG. 1 is preferably rectangular in shape and about three inches wide and about ten inches long. The face 12 of the exterior case 11 is preferably flat and supports numerous check-off switches 20 mounted linearly along long edge 13 of the face 12. The face 12 also supports numerous red warning indicators 30 mounted linearly along long edge 14 of the face 12. A master green indicator 40 is mounted near the top 15 of the face 12, while a reset button 45 is mounted near the bottom 16 of the face 12. Numerous associated item labels 50 are mounted on the face 12 and positioned between a corresponding check-off switch 20 and a red warning indicator 30, so that it is evident from a quick glance at the face 12 that a particular check-off switch 20 and red warning indicator 30 relates to an associated item identified by a label 50. A power cable 60 enters the vehicle electronic check-off 10 at the top end 15.

The electronic vehicle check-off rectangular case 11 is preferably manufactured of high density plastics and designed for comfortable ergonomic use. The case 11 may also formed with built-in features for hanging or attaching the device to convenient locations in a vehicle.

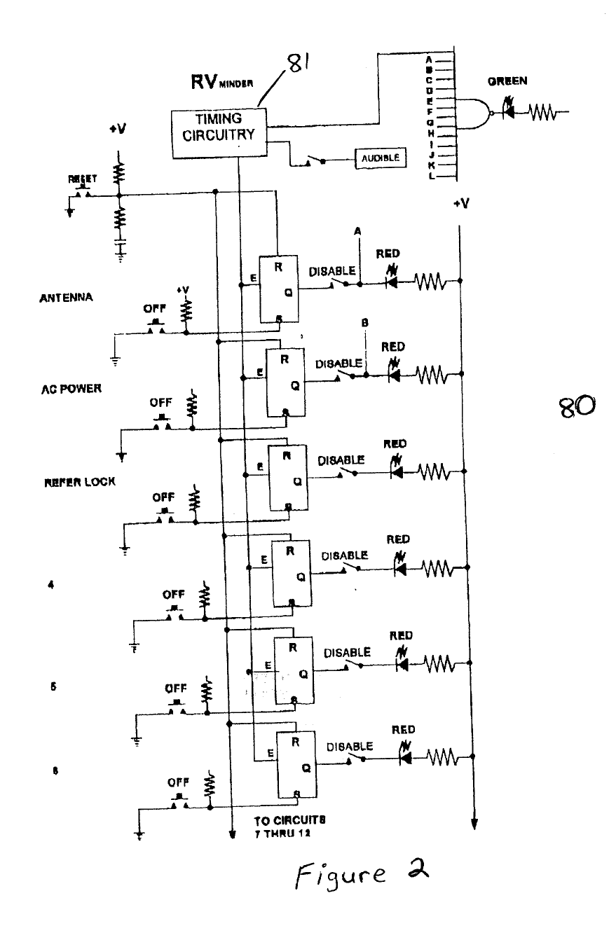

The electrical circuitry 80 which operates the electronic vehicle check-off is illustrated in FIG. 2. The circuitry is powered from the vehicle as 12 volt direct current, and powered up when the vehicle is started. Upon power up the red warning indicators 30 blink as provided by timing circuit 81. The red warning indicators 30 may also be individually incapacitated using disable switch 82 while the red warning indicators are individually disabled by check-off switches 20.

The associated item labels 50 are preferably designed for writing the name of a particular item associated with each red warning indicator. The labels may be adhesive labels, or paper labels retained by a trough arrangement on the face 12 of the device allowing for easily replacing the labels with new identifiably associated items. The labels are preferably located adjacent to and between a red warning indicator and a corresponding momentary switch. Some items which may be included on the labels include; electrical, sewer, canopy, antenna, wheel cover, etc.

It is noted that the embodiment of the vehicle electronic check-off described herein in detail for exemplary purposes is of course subject to many different variations in structure, design, application and methodology. Because many varying and different embodiments may be made

What is claimed is:

1. A vehicle electronic check-off device to remind a recreation vehicle operator of several associated items to be checked before operating the vehicle, comprising;
a) a plurality of momentary switches and associated red warning indicators each associated with a particular associated item,
b) a label means for naming each associated item in a location adjacent to a momentary switch and associated red warning indicator, and
c) electrical circuitry which when powered activates the associated red warning indicators and wherein each momentary switch, when activated, incapacitates a particular red warning indicator associated with a particular associated item, and a green indicator which illuminates when all red warning indicators have been incapacitated.

2. The vehicle electronic check-off device as set forth in claim 1 wherein the device further comprises a audible alarm which activates periodically and momentarily upon power up of the device and before all momentary switches have been activated.

3. The vehicle electronic check-off device of claim 1 wherein the device further comprises numerous deactivation switches each of which incapacitates a momentary switch.

4. The vehicle electronic check-off device of claim 1 wherein the device further comprises a power supply cord easily connectable to a vehicle.

5. The vehicle electronic check-off device of claim 1 wherein the labeling means further comprises a label retaining trough positioned between each momentary switch and each red warning indicator, which receives a paper label so that the red warning indicator and momentary switch are associated with a particular item identified on the paper label.
